(19) United States
(12) Patent Application Publication
(10) Pub. No.: US 2026/0225681 A1
(43) Pub. Date: Aug. 6, 2026

(54) Foldable Vehicle

(71) Applicant: HEDZ MAGYARORSZÁG KFT, Szeged (HU)

(72) Inventors: Áron Fejes, Szeged (HU); Sándor Fejes, Szeged (HU)

(21) Appl. No.: 19/159,779

(22) PCT Filed: Oct. 27, 2023
(86) PCT No.: PCT/HU2023/050074

§ 371 Date: Aug. 26, 2025

(30) Foreign Application Priority Data
Mar. 2, 2023 (HU) P2300077

(51) Int. Cl. B62K 15/00; B62K 21/22; B62M 6/40

(52) U.S. Cl. CPC B62K 15/006; B62K 21/22; B62M 6/40

(57) ABSTRACT

The foldable vehicle (100) comprises a steering rod (210) having a centerline (250), a front wheel (800) connected to the steering rod (210), said front wheel having a rotational axis (850), a support frame (300) having an upper surface (310) and a centerline (350) along said upper surface, and a rear wheel (900) connected to the support frame (300) and having a rotational axis (950). The vehicle (100) is configured to have an unfolded state and a folded state, wherein in the unfolded state, the first and second centerlines (250, 350) are located in one plane and form a predetermined angle, whereas in the folded state, the first and second centerlines (250, 350) are parallel to each other or form an angle of at most 30°. A first hinged member (400) is rotatably connected to the steering rod (210) with forming a specific angle with respect to the centerline (250) of the steering rod, wherein a hinge at one end of the first hinged member (400) has a first rotational axis (450). A second hinged member (500) is rotatably connected to the support frame (300) with forming a specific angle with respect to the centerline (350) of the support frame, wherein a hinge at one end of the second hinged member (500) has a second rotational axis (550). The first and second hinged members (400, 500) are interconnected by a connecting member (600) configured to rotate about the first rotational axis (450) relative to the first hinged member (400), and about the second rotational axis (550) relative to the second hinged member (500). The angle formed by the centerline (250) of the steering rod (210) and the rotational axis (450) of the first hinged member (400), the angle formed by the centerline (350) of the support frame (300) and the centerline (550) of the second hinged member (500), and the angle formed by the first and second rotational axes (450, 550) are determined so that in the folded state of the vehicle (100), the steering rod (210) and the support frame (300) are located next to each other in such a way that their centerlines (250, 350) are substantially parallel to each other, and the front and rear wheels (800, 900) are located next to each other so that their rotational axes (850, 950) are substantially parallel to each other. The vehicle (100) further comprises a locking mechanism (700) for preventing the first hinged member (400) and the connecting member (600) from rotating relative to each other, and the second hinged member (500) and the connecting member (600) from rotating relative to each other both in the unfolded state and the folded state of the vehicle (100).

The invention relates to a foldable vehicle, in particular a foldable scooter.

Foldable vehicles, such as scooters, bicycles, etc., are becoming more and more popular due to their simple structural design, as well as their low weight and much smaller storage space requirements compared to conventional vehicles.

Among the foldable scooters and bicycles currently available on the market, one of the most compact solutions is the electric scooter “Mi Electric Scooter 3” of the company Xiaomi, the steering column of which can be folded down to the footrest by releasing a fastening device. However, after folding, the user must lift the scooter for transport, which makes transporting the vehicle difficult. A similar technical solution for folding the scooter is also used by the scooter “Dolly” of the company Glion.

The scooter “ET Scooter” of Shenzhen Acetech Technology Co. Ltd can also be folded in an extremely compact way, the frame of which has a joint with two axes of rotation, which allows the vertical handlebar and the inclined support rod of the rear wheel to be folded side by side. A disadvantage of this solution is that the wheels are perpendicular to each other in their storage position, so rolling the folded vehicle on two wheels is not possible. For this reason, additional rollers are typically mounted on the structure to transport these vehicles.

It is an object of the invention to eliminate the above-mentioned problems by providing an easily foldable vehicle that not only takes up little space when folded, but can also be transported comfortably by the passenger, for which the most obvious solution is to simply roll it on its existing wheels.

The above objects are achieved by providing a foldable vehicle according to claim 1. Preferred embodiments of the foldable vehicle according to the invention are defined by the dependent claims.

The invention will be described in detail below with reference to the drawings. In the drawings:

FIG. 1 shows a preferred embodiment of the foldable vehicle according to the invention in a perspective view in an unfolded state;

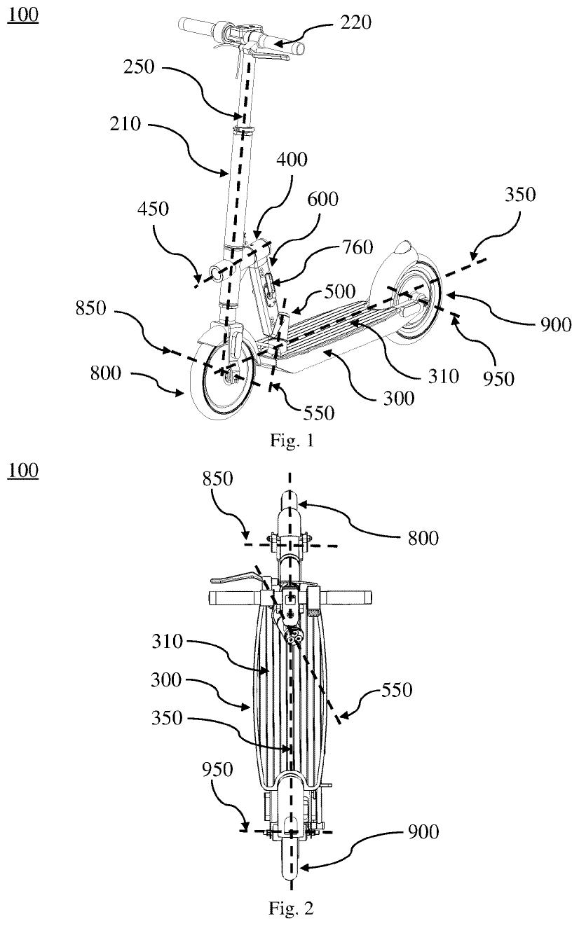

FIG. 2 is a top view of the vehicle shown in FIG. 1 in the unfolded state;

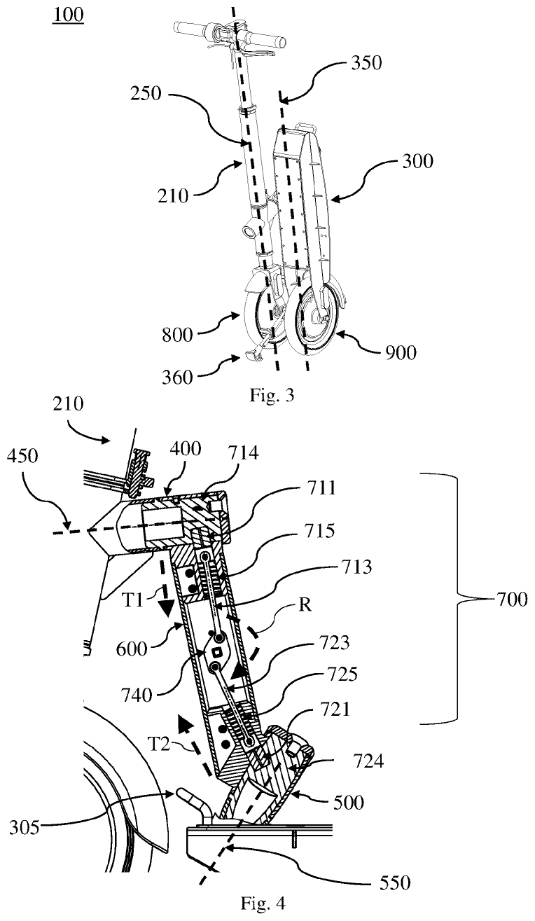

FIG. 3 is a perspective view of the vehicle shown in FIG. 1 in the folded state;

FIG. 4 illustrates the design of the locking structure used in the folding mechanism of the foldable vehicle according to the invention in a partially sectional side view;

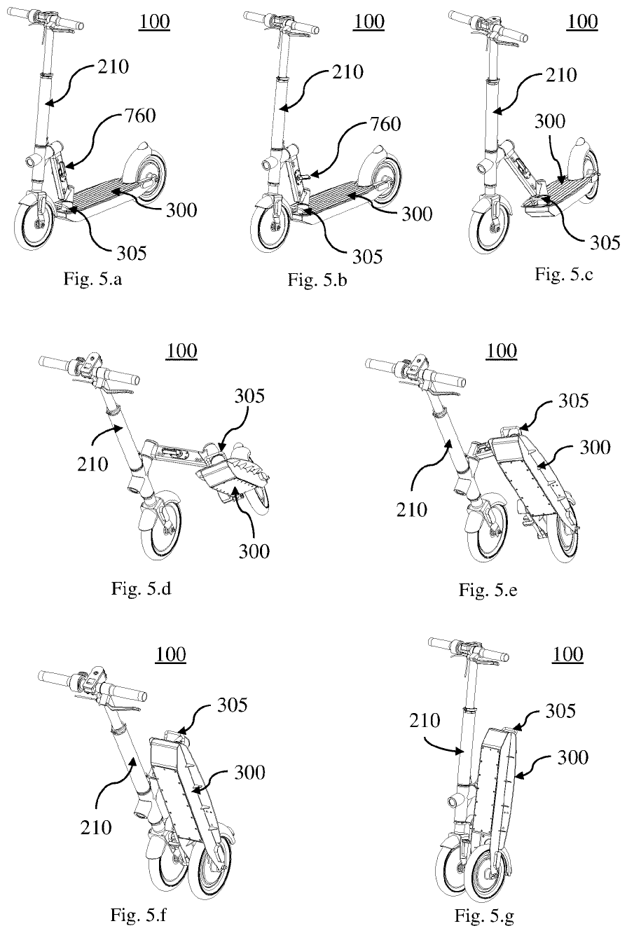

FIGS. 5.a to 5.g illustrate the main phases of folding the foldable vehicle according to the invention; and

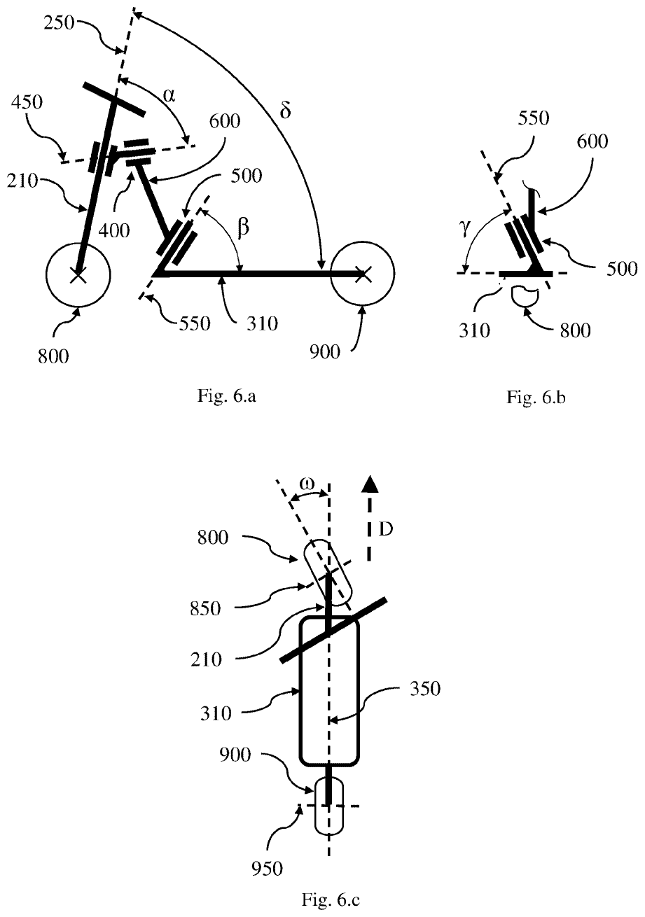

FIGS. 6.a to 6.c schematically illustrate the spatial position of the geometric angles defined by the main structural elements of the foldable vehicle according to the invention in side view, front view and top view, respectively.

The main structural elements of the foldable vehicle according to the invention are presented below through a two-wheeled scooter with reference to the accompanying drawings. However, it is obvious to a person skilled in the art that the working principle of the folding mechanism used in the foldable vehicle according to the invention may be applied not only for two-wheeled scooters, but with simple modifications also for three-wheeled scooters, bicycles, tricycles, etc., for example.

As shown in FIGS. 1 and 2, the foldable two-wheeled vehicle 100 according to the invention may be provided in form of a two-wheeled scooter. The vehicle 100 comprises a steering assembly having a steering rod 210 with a first centerline 250. The upper end of the steering rod 210 comprises a cross bar 220, which may be equipped with, for example, a grip and a brake lever, for example a mechanical brake lever or, in the case of a powered drive, also with other operating elements. The powered drive of the vehicle 100 may be an electric motor or any other type of motorized drive. The other end of the steering rod 210, which is usually formed as a fork, is connected to a front wheel 800 having a rotational axis 850 by means of bearing.

The vehicle 100 according to the invention has a support frame 300 which has a carrier surface 310 suitable for transporting the user. The carrier surface 310 has a centerline 350. In the unfolded (utilization) state of the vehicle 100, the centerline 250 of the steering rod 210 and the centerline 350 of the carrier surface 310 are located in the same plane and together form a predetermined angle δ, as it can be seen schematically in FIG. 6.a. A rear wheel 900 having a rotational axis 950 is also connected to the support frame 300 of the vehicle 100 according to the invention, also by means of bearing.

The foldable vehicle 100 according to the invention may even comprise two or more wheels at the front and/or rear, provided that the wheels do not hinder the folding of the vehicle 100.

The folding of the vehicle 100 according to the invention can be carried out by using a folding mechanism that basically acts as a rotary robot arm with two degrees of freedom. One end point of the folding mechanism is attached to the steering rod 210, and the other end point thereof is attached to the front part of the support frame 300.

As shown in FIGS. 1 and 2, the folding mechanism consists of a first hinged member 400, a second hinged member 500 and a connecting member 600. The first hinged member 400 having a rotational axis 450 is coupled to the steering rod 210. The rotational axis 450 and the centerline of the first hinged member 400 coincide. The centerline 250 of the steering rod 210 and the rotational axis 450 of the first hinged member 400 form an angle α shown in FIG. 6.a

The second hinged member 500 is coupled to the support frame 300, for example to its upper carrier surface 310. The second hinged member 500 has a rotational axis 550 which is not necessarily parallel to the plane defined by the centerline 250 of the steering rod 210 and the centerline 350 of the support frame 300. The carrier surface 310 of the support frame 300 and the rotational axis 550 of the second hinged member 500 form a solid angle, the lateral projection of which forms an angle β, and the front projection of which forms an angle γ as schematically illustrated in FIGS. 6.a and 6.b.

The first hinged member 400 and the second hinged member 500 are connected to each other by a rigid connecting member 600 so that one end of the connecting member 600 is connected to the first hinged member 400 and can rotate about its rotational axis 450, whereas the other end of the second hinged member 500 is connected to the second hinged member 500 and can rotate about its rotational axis 550.

In order to provide stability of the folding mechanism in both the unfolded and the folded positions, the folding mechanism includes a locking mechanism 700 that can be locked and released manually or automatically. After releasing the locking mechanism 700, it becomes possible to turn the hinges of the two hinged members 400, 500 and thus to turn, relative to each other, the first hinged member 400, the second hinged member 500 and the connecting member 600, which together form the folding mechanism. FIG. 4 illustrates a locking mechanism 700 used in a preferred embodiment of the vehicle 100 according to the invention. In this embodiment, the locking mechanism 700 is in the form of a manually operated mechanical locking mechanism.

The locking mechanism 700 comprises two driving rods 713, 723, which are connected, by means of bearing, to a base member 740 that can be rotated around a rotational axis perpendicular to the longitudinal axis of the connecting member 600. A locking pin 711 is connected to the other end of the upper driving rod 713 by means of bearing, wherein said locking pin 711 can be pushed into or pulled out from a first hole and a second hole, both formed in an insert 714 at the upper end of the connecting member 600. The insert 714 is pushed inside the first hinged member 400 and fixed therein in a rotation-free manner. In the unfolded, utilization state of the vehicle 100, the locking pin 711 is engaged with the first hole of the insert 714, whereas in the folded, transport/storage state of the vehicle 100, the locking pin 711 is engaged with the second hole of the insert 714.

The upper end of the driving rod 713 is biased toward the locking pin 711 by a spring 715 so that the locking pin 711 is located in one of the holes of the insert 714 in its default position. The locking pin 711 can be manually pulled back from the hole against the force of the spring 715 in such a way that the base member 740 is rotated in the direction of the arrow R, in the clockwise direction of release, as a result of which the driving rod 713 moves towards the base member 740 in the direction indicated by the arrow T1 while pulling the locking pin 711 with it. The base member 740 can be turned using a release lever 760 arranged on the outer surface of the connecting member 600.

The second hinged member 500 of the locking mechanism 700 operates in the same way as described above. Accordingly, the locking mechanism 700 includes a locking pin 721 connected to the lower driving rod 723, which engages with the corresponding holes of the insert 724 located in the second hinged member 500. The locking pin 721 can be manually pulled back from the hole against the force of the spring 725, and when released, it moves in the direction indicated by the arrow T2.

The locking mechanism 700 may be carried out not only with the mechanical locking mechanism shown in FIG. 4, but in other embodiments of the vehicle 100 according to the invention, also with electromechanical devices, e.g. electromagnet, electric servo motor, or any other manually operated fastener, such as belt, carabiner, buckle, strap, clamp, bayonet lock, etc.

As shown in FIGS. 1 and 2, and also in FIG. 6.b, the centerline of the second hinged member 500, and accordingly the rotational axis 550 as well, is preferably inclined with respect to the plane defined by the rotational axis 250 of the steering rod 210 and the centerline of the carrier surface 310 of the support frame 300, so that it intersects said plane at the connection point of the connecting member 600 and the second hinged member 500, and as shown in FIG. 6.b, the rotational axis 550 and the plane of the support surface 310 form an angle γ in the front view.

Inclination of the rotational axis 550 by an angle γ is necessary because in the present embodiment, the geometric constraint that the rotational axes 850 and 950 should be parallel to each other, or should even be coincident, can only be satisfied in this way when in the folded state of the vehicle, the steering rod 210 and the support frame 300 are side by side, in a parallel position.

In a preferred embodiment of the vehicle 100 according to the invention, the above-mentioned geometric angles are set to the following values:

$$α = 72 °$$

$$β = 58.1 °$$

$$γ = 71.34 °$$

$$δ = 78 °$$

$$ω = 0 °$$

where ω is a fixable angular position of the steering rod 210 relative to the direction of forward travel of the vehicle.

It should be noted that the values of the above angles are only examples, and it is obvious for a person skilled in the art that the value of the angles may be modified freely within specific ranges, but upon changing the value of any angle, the values of the other angles and the length of the members of the connecting mechanism should also be modified accordingly so that the special geometric conditions and constraints are met. The values of the angles are to be chosen so that the vehicle 100 can be transformed from its unfolded state to its folded state as described below.

FIG. 3 illustrates the folded state of the vehicle 100 according to the invention. In this state, the steering rod 210 and the support frame 300 are located next to each other in such a manner that the centerline 250 of the steering rod 210 and the centerline 350 of the support surface 310 are parallel to each other, or preferably, they form an angle of at most 30°, so that they occupy a substantially small space. Another particularly advantageous feature of the vehicle according to the invention is that in its folded state, the front wheel 800 and the rear wheel 900 are located next to each other, so that the rotational axis 850 of the front wheel 800 and the rotational axis 950 of the rear wheel 900 are parallel to each other, or even coincide when the wheels are of the same size. Due to this configuration, the folded vehicle 100 can be rolled stably on its own two wheels by holding the steering rod 210, like a two-wheeled shopping trolley bag, so it does not need to be lifted for transport, and it can also be brought to a stable standing position by means of a kickstand 360. In this folded state, the rotational axes 850, 950 of the wheels 800, 900 are perpendicular or substantially perpendicular to the centerline 250 of the steering rod 210 and to the centerline 350 of the carrier surface 310.

In accordance with the above requirements, in an alternative embodiment, the front and rear wheels 800, 900 have different diameters. In this case, it is essential for the stable rolling of the vehicle that both wheels 800, 900 are in contact with the ground in the folded state.

In a particularly preferred embodiment of the vehicle 100 according to the invention, which is shown in FIGS. 1 to 3, the front and rear wheels 800, 900 the vehicle 100 are of the same size, and in the folded state of the vehicle 100, the rotational axes 850, 950 of the wheels 800, 900 are substantially coincident.

The main phases of the folding process of the foldable vehicle 100 according to the invention are illustrated in FIGS. 5.a to 5.f.

In order to fold the vehicle 100, it is preferred that the steering rod 210 first be attached to the first hinged member 400 using a suitable mechanical lock. Locking is performed at a turning angle ω defined relative to the straight, forward direction D of the vehicle 100 (as indicated in FIG. 6.c). In the illustrated embodiment ω=0°. The purpose of this arrangement is to bring the steering rod 210, which can otherwise be turned relative to the support frame 300 and thus also relative to the first hinged member 400, and also the front wheel 800 into a stable position and parallel to the rear wheel 900 in the folded state of the vehicle, which is required for the easy rolling of the vehicle in its folded state. After that, the mechanical locking mechanism of the connecting mechanism is to be released by turning the release lever 760 shown in FIG. 5.a in a clockwise direction. Once the locking pins 711, 721 have left the respective holes, they no longer hinder the rotation of the connecting member 600 about the hinged members 400 and 500. This situation is illustrated in FIG. 5.b. Then, by lifting the vehicle in a substantially vertical direction, while holding the handle 305 located at the front of the support frame 300, the steering rod 210 and the support frame 300 can be turned next to each other as shown in FIGS. 5.c to 5.f.

In the end state shown in FIG. 5.f, i.e. when the vehicle 100 is in its folded position, the locking pins 711, 721 of the mechanical locking mechanism are aligned with the corresponding holes, as a result of which the locking pins 711, 721 are automatically pushed into the holes by the tensioned springs 715, 725 and thereby they fix the folding mechanism in the folded state of the vehicle 100. After locking, the vehicle 100 may be set up into a stable vertical position using the kickstand 360 as shown in FIGS. 3 and 5.g.

To unfold the vehicle 100, the mechanical locking mechanism can be released by turning the release lever 760 in a clockwise direction, causing the steering rod 210 and the support frame 300 to be released, and the vehicle 100 can be transformed again into an the unfolded, utilization state practically by its own weight, as shown in FIG. 5.a. Finally, for use, the mechanical lock of the steering rod is to be unlocked.

The foldable vehicle 100 according to the invention has, among others, the following advantages. The vehicle 100 is compact in its folded state, and due to the wheels 800, 900 located side by side, parallel to each other, it can be pulled or pushed comfortably and stably on its own wheels 800, 900 by tilting forward or backward around the common rotational axes 850 and 950 while holding the end of the steering rod 210. The vehicle 100 can be folded simply by moving the steering rod 210 and the support frame 300 in the appropriate direction. Due to the release lever 760, the mechanical locking mechanism of the folding mechanism can be activated easily and comfortably by exerting only slight force.

It is also an advantageous feature of the vehicle 100 according to the invention to be mentioned that unfolding it from the folded state to the utilization state is extremely easy because upon releasing by the release lever 760, the connecting member 600 and the support frame 300 can be moved from their vertical or near vertical position into their unfolded positions with minimal external force, mainly due to their own weight. Then, when the end state is reached, re-locking takes place automatically.

It should further be noted that another advantageous feature of the vehicle is that the directions of the rotational axes 450 and 550, which allow folding, are designed in such a way that during use, when the user is staying on the support frame 300, the loads mainly occur in the pins of the heavy-duty hinged members 400 and 500, and they do not cause stress for the weaker locking pins.

1. A foldable vehicle (100) comprising
a steering rod (210) having a centerline (250),
a front wheel (800) connected to the steering rod (210), said front wheel having a rotational axis (850),
a support frame (300) having an upper carrier surface (310) and a centerline (350) along said carrier surface,
a rear wheel (900) connected to the support frame (300) and having a rotational axis (950),
wherein the vehicle (100) is configured to have an unfolded state and a folded state, wherein in the unfolded state, the first and second centerlines (250, 350) are located in one plane and form a predetermined angle (δ), whereas in the folded state, the first and second centerlines (250, 350) are parallel to each other or form an angle of at most 30°,
characterized in that
a first hinged member (400) is rotatably connected to the steering rod (210), said steering rod forming an angle (α) with the centerline (250) of the steering rod, wherein a hinge at one end of the first hinged member (400) has a first rotational axis (450),
a second hinged member (500) is connected to the support frame (300), said support frame forming an angle (β) with the centerline (350) of the support frame, wherein a hinge at one end of the second hinged member (500) has a second rotational axis (550),
the first and second hinged members (400, 500) are interconnected by a connecting member (600) configured to rotate about the first rotational axis (450) relative to the first hinged member (400), and about the second rotational axis (550) relative to the second hinged member (500), and
wherein the angle (α) formed by the centerline (250) of the steering rod (210) and the rotational axis (450) of the first hinged member (400), the angle (β) formed by the centerline (350) of the support frame (300) and the centerline (550) of the second hinged member (500), and angle (y) formed by the second rotational axis (550) and the plane of the carrier surface (310) of the support frame (300) in front view are determined so that in the folded state of the vehicle (100),
the steering rod (210) and the support frame (300) are located next to each other in such a way that their centerlines (250, 350) are substantially parallel to each other, and
the front and rear wheels (800, 900) are located next to each other so that their rotational axes (850, 950) are substantially parallel to each other, and
wherein the vehicle (100) further comprises a locking mechanism (700) for preventing the first hinged member (400) and the connecting member (600) from rotating relative to each other, and the second hinged member (500) and the connecting member (600) from rotating relative to each other, both in the unfolded state and the folded state of the vehicle (100).

2. The vehicle (100) according to claim 1, characterized in that the front and rear wheels (800, 900) of the vehicle (100) are of the same size, and the rotational axes (850, 950) of the wheels (800, 900) substantially coincide in the folded state of the vehicle (100).

3. The vehicle (100) according to claim 1, characterized in that the locking mechanism (700) comprises at least one of the elements of the following group: mechanical locking mechanism, electromagnet, electric motor, other manually operated fastening element, for example belt, carabiner, buckle, strap, clamp, bayonet lock.

4. The vehicle (100) according to claim 3, characterized in that the locking mechanism (700) is in the form of a mechanical locking mechanism and comprises a release lever (760) for releasing the connecting member (600) simultaneously from the two hinged members (400, 500).

5. The vehicle (100) according to claim 1, characterized in that the steering rod (210) is provided with a mechanical lock for non-rotational attachment to the first hinged member (400), wherein the locked steering rod (210) has a predetermined angle (▪) of turn.

6. The vehicle (100) according to claim 1, characterized in comprising more than one front wheels (800) and/or more than one rear wheel (900).

7. The vehicle (100) according to claim 1, characterized in comprising an electric drive or another type of motorized drive.
